(19) United States
(12) Patent Application Publication
(10) Pub. No.: US 2026/0343187 A1
(43) Pub. Date: Oct. 29, 2026

(54) METHOD OF SETTING UP A SIDELINK COMMUNICATION

(71) Applicant: Sheng-Liu Lin, Hsinchu City (TW)

(72) Inventor: Sheng-Liu Lin, Hsinchu City (TW)

(21) Appl. No.: 19/560,401

(22) Filed: Mar. 9, 2026

Related U.S. Application Data
(60) Provisional application No. 63/778,437, filed on Mar. 27, 2025.
(60) Provisional application No. 63/942,577, filed on Dec. 17, 2025.

(51) Int. Cl. H04W 4/12; G06F 3/0482; H04W 92/18

(52) U.S. Cl. CPC H04W 4/12; G06F 3/0482; H04W 92/18

(57) ABSTRACT

A method of setting up a sidelink communication in either mode 1 or mode 2 is disclosed. The method comprises the steps of receiving a command to initiate or activate a chat function; providing a Chat list for selection; determining a source Application Layer ID corresponding to a source UE and a destination Application layer ID corresponding to a destination UE; providing a request of service with the source and destination Application Layer IDs; determining source and destination Layer-2 IDs; activating a sidelink communication with the source and destination Layer-2 IDs via a PC5 interface; generating Sidelink Service Characteristics based on received data and requesting for a semi-persistent transmission with the Sidelink Service Characteristics on the sidelink communication to the cellular network; transmitting the received data to the destination UE in segments on the sidelink communication and marking a Cast Type Indicator of a SCI as unicast.

### CROSS-REFERENCE TO RELATED APPLICATIONS

The present application claims the benefit of U.S. Provisional Patent Application Ser. No. 63/778,437, filed on Mar. 27, 2025, and U.S. Provisional Patent Application Ser. No. 63/942,577, filed on Dec. 17, 2025. The entire disclosures of U.S. Provisional Patent Application Ser. No. 63/778,437 and U.S. Provisional Patent Application Ser. No. 63/942,577 are incorporated herein in their entireties by reference.

### FIELD

This disclosure generally relates to wireless communication networks, and more particularly, to a method of setting up a sidelink communication.

### BACKGROUND OF THE INVENTION

V2X (Vehicle-to-Everything) communication refers to V2V (vehicle-to-vehicle), V2I (vehicle-to-infrastructure), V2R (vehicle-to-pedestrian) or V2N (vehicle-to-network) communication. V2V, V2I and V2R refer to direct communication between a vehicle and device. V2N refers to network communication between the vehicle and a 4G/5G network via base stations.

UE (User Equipment), also named a mobile station or mobile terminal, able to be embedded or installed in a vehicle, has the capability of data transmission and reception from a base station (eNodeB, gNodeB or the likes) of a cellular network or from another UE wirelessly.

However, there is no tool or software which helps a user set up a sidelink communication or configure the parameters of sidelink communication in order to meet the user's demands. Moreover, sidelink is able to work in mode 1 and mode 2. Due to the differences of the nature, it makes the setting up or configuration complicated.

### SUMMARY

In order to resolve the issues addressed above, two embodiments of the method of setting up a sidelink communication are disclosed. The first embodiment discloses a method comprising the steps of registering to a cellular network; receiving a command to initiate or activate a chat function; providing a Chat list for selection and the selection refers to a destination UE; determining a source Application Layer ID corresponding to a source UE and a destination Application layer ID corresponding to the destination UE; providing a request of service with the source and destination Application Layer IDs; determining a source Layer-2 ID corresponding to the source UE and a destination Layer-2 ID corresponding to the destination UE; activating a sidelink communication with the destination UE with the source and destination Layer-2 IDs via a PC5 interface; generating a plurality of Sidelink Service Characteristics based on received data and requesting for a semi-persistent transmission with the Sidelink Service Characteristics on the sidelink communication to the cellular network via a UU interface; and transmitting the received data to the destination UE in segments on the sidelink communication via the PC5 interface and marking a Cast Type Indicator of a SCI as unicast. The Chat list is generated based on Contacts or Directories or incorporated into Contacts or Directories. The source Layer-2 ID is generated by calculating a value of the Application Layer ID, device ID, vehicle ID, user ID or application ID the source UE. The command is a response to an action on a UI, keyboard, bottom or a voice recognition. The Sidelink Service Characteristics at least include a plurality of latency requirements, a message size and a transmission frequency.

The first embodiment discloses a method comprising the steps of Receiving a command to initiate or enable a chat function; providing a Chat list for selection and the selection refers to a destination UE; determining a source Application Layer ID corresponding to a source UE and a destination Application layer ID corresponding to the destination UE; providing a request of service of with the source and destination Application Layer IDs; determining a source Layer-2 ID corresponding to the source UE and a destination Layer-2 ID corresponding to the destination UE; generating Sidelink Service Characteristics based on received data; following a listening before transmitting procedure and available radio resources to locate available RB (Resource Block) to transmit a Direct Communication Request message to the destination UE via a PC5 interface; transmitting the received data in segments using the same RB on PSSCH via the PC5 interface and marking a Resource Reservation Period field and a Cast Type Indicator of as unicast of SCI on PSCCH. The available radio resources are either provisioning or updated during the last connection with the cellular network.

### BRIEF DESCRIPTION OF THE DRAWINGS

FIG. 1 is a block diagram of a device 10.

FIG. 2 illustrates a first embodiment of the method of setting up a sidelink communication in mode 1.

FIG. 3a-3d illustrates a UI for operating a software application.

FIG. 4 illustrates an exemplary structure of contacts or directories.

FIG. 5 illustrates a second embodiment of the method of setting up a sidelink communication in mode 2.

### DETAILED DESCRIPTION

3GPP TS 38.355 v18.6.0 is a 3GPP standard published on Jul. 24, 2025 and discloses a protocol specification of Sidelink Positioning Protocol (SLPP). All the definitions of technical terms used in this disclosure may refer to that standard primarily.

V2X (Vehicle-to-Everything) is a mechanism for a UE placed in a vehicle which is able to send messages, sensed data, traffic data, location/position information, or other information to another UE placed in another vehicle, RSU (Roadside Unit), pedestrian or infrastructure. A sidelink communication is disclosed for achieving the above purpose without intervening the operation of a cellular network.

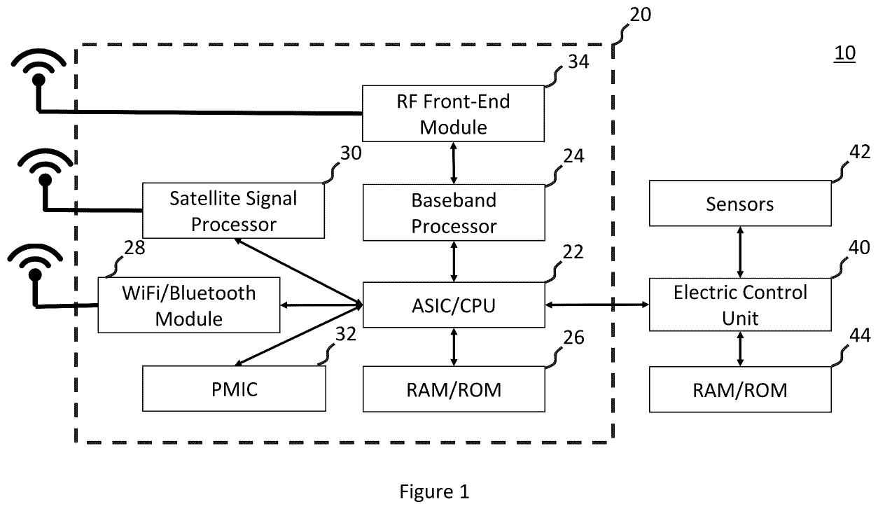

As illustrated in FIG. 1, a UE 20 is a logic unit implemented by a device 10 and has the capability of data transmission wirelessly with a relay UE, base station, a satellite (relay), RSU or a drone (Unmanned Aerial Vehicle or UAV) inside or outside a cellular network. It is preferable that the UE 20 also has the capability of phone calling. The function of the UE 20 is mainly performed by an ASIC/CPU (Application-Specific Integrated Circuit/Central Processing Unit) 22 to execute instructions, procedures or protocols in form of software, firmware and so on, and generate digital data and or process received digital data. ASIC/CPU 22 is also able to process AI related instructions and data. In order to perform comprehensive functions, the ASIC/CPU 22 may work with Baseband processor 24, RAM/ROM 26, WiFi/Bluetooth Module 28, Satellite Signal Processor 30, PMIC (Power Management IC) 32 and so on.

Baseband processor 24 mainly converts digital data received from the ASIC/CPU 22 into RF (radio frequency) signals, passes the RF signals to RF Front-End Module 34 for amplifying the RF signals for wireless transmission, converts RF signals received from RF Front-End Module 34 into digital data, and passes received digital data to the ASIC/CPU 22 for processing.

RAM/ROM 26 is used to store all the digital data, software and firmware of UE 20. WiFi/Bluetooth Module 28 provides short-distance communication capacity with another UE or device. Moreover, WiFi/Bluetooth Module 28 is able to provide a non-3GPP connection (either trusted and untrusted connection) to access the cellular network if the connection via the RF Front-End Module 34 does not work.

Satellite Signal Processor 30 is used to receive GNSS (Global Navigation Satellite System) data, such as GPS (Global Positioning System), GLONASS (Global Navigation Satellite System), BDS (Beidou Navigation Satellite System), Galileo and so on, from the satellites, RSU or drones. The GNSS data are received/measured and transferred to the ASIC/CPU 22 in order to calculate the location value of the UE 20/device 10. The Satellite Signal Processor 30 may have the capability of measurement and process of the GNSS data directly and transfers calculated location to the ASIC/CPU 22. Moreover, the UE 20 is able to connect to a satellite, RSU or drone to perform data transmission via the Satellite Signal Processor 30 or Baseband processor 24, preferred via a UU interface.

PMIC 32 is mainly to receive and supply power for consumption for each component of the UE 20. The power is received from a power source, such as a battery (not shown), solar panel, fuel cells or a power source. The PMIC 32 includes power converter, transformer, regulator or booster to convert a received power, either AC (Alternating Current) or DC (direct current), to a DC power before supplying the power to those components.

Device 10 may be a smartphone, RSU, glasses, personal computer, laptop computer, sports camera, wireless router, VR (Virtual Reality) device, AR (Augmented Reality) device, drone, vehicle, boat or aircraft. Taking the vehicle as an example in the below description, the UE 20 is able to provide the capability of data transmission to transmit the digital data received from an ECU (Electric Control Unit) 40 of device 10 to another UE wirelessly, and vice versa. Sometimes the device 10 is also named OBU (On Board Unit).

ECU 40 plays as a core processor of the device 10 and controls various functions of the device 10. For example, the functions include a fuel injection, ignition and ancillaries of an engine, operations of a multimedia platform, processes all of the data and signals generated by other components of the device 10 and stores the data into RAM/ROM 44 (or RAM/ROM 26). Due to the extensive capability and technology improvement, ECU 40 may be incorporated into ASIC/CPU 22 and RAM/ROM 44 may be incorporated into RAM/ROM 26.

RAM/ROM 44 functions as RAM/ROM 26 to store all of the digital data, software and firmware of the ECU 40 or Device 10.

Sensor 42 which is used to sense the status of operation of one or more components of the device 10. For example, a brake sense is used to sense the status of operation of brake; a tire pressure sense is used to sense the status of air pressure of a tire or tires; a battery sensor is used to sense the operation current, temperature, voltage or air pressure of a battery bank; an altitude sensor is used to measure the pressure to calculate the attitude of the UE 20. The sensor 42 reports a sensed value to the ECU 40 regularly. ECU 40 is able to compare the sensed value with a threshold value to determine a normal state or an abnormal state of the operation. The sensor 42 may have the capability to determine the state directly and pass it to the ECU 40. The threshold is preferably pre-determined but it is workable to provide a user interface allowing a user of the device 10 to set a value. Moreover, another type of sensor which does not sense any operation but reports a switch status may be used as well. For example, a construction engineer can turn on a switch to indicate an operation of construction. When the switch is turned on, it reports a positive or negative value to the ECU 40.

Sidelink communication is able to work in either of modes 1 and 2. Mode 1 is a network-scheduled resource allocation. In mode 1 the UE 20 enters or stays in an RRC-Connected state and receives radio resources assigned from the cellular network. Mode 2 is UE-autonomous resource selection. In mode 2 the radio resources are either pre-configured or updated. The former means the UE 20 relies on the parameters stored in USIM (Universal Subscriber Identity Module). The latter means the radio resources are updated in the last connection to the cellular network. there is no mandatory requirement on the RRC state.

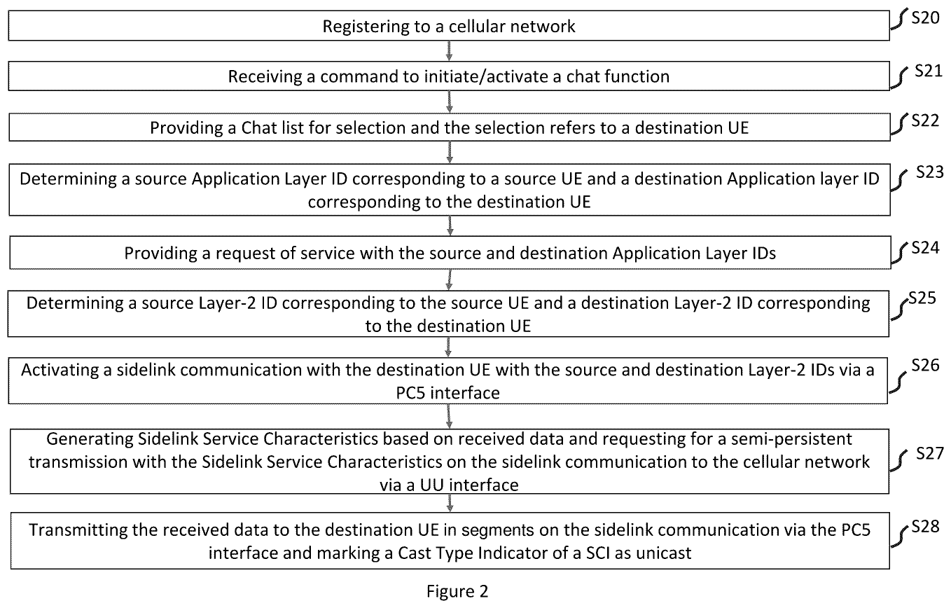

FIG. 2 illustrates a first embodiment of the method of setting up a sidelink communication in mode 1 by the UE 20. The method is described in detail below.

Step S20: Registering to a cellular network. The UE 20 performs a network selection procedure to determine which PLMN (Public Land Mobile Network) or SNPN (Stand-alone Non-Public Network) it will attempt to register with. The UE 20 may perform a cell selection procedure to search and find a serving cell to camp on. The cell may be provided by a base station, satellite (relay) or drone. If the UE 20 camps on a cell successfully, its RRC state enters an RRC_IDLE state. The UE 20 transmits a RRCSetupRequest message, disclosing the UE identity information, such as SUPI, SUCI (concealed SUPI), or TMSI/5G-S-TMSI, to the cellular network to establish connectivity. When a RRCSetupComplete message is received, a connection with the cellular network via the serving cell is established (referring to the UU interface) and its RRC state enters an RRC_Connected state from the RRC_IDLE state. The cellular network broadcasts SIB (System Information Block) to the UE 20. SIB12 includes specific radio resources for sidelink communication in mode 1 available for the UE 20. When the UE 20 enters the RRC_Connected, it is able to send requests for services and transmits/receives data from the cellular network. The cellular network may signal the specific radio resources for sidelink communication in mode 1 to the UE 20 directly after receiving a request.

Beside connecting to a base station, the UE 20 may perform a scan and register procedure to link to an anchor AP (Access Point or Radio unit) of the cellular network in a cell-free architecture. The UE 20 scans broadcasting messages from the anchor AP (the one with strongest signal strength) and follows the synchronization parameters retrieved from the broadcasting messages to transmit the identity information to the anchor AP in order to register with the cellular network. After registering to the cellular network, the UE 20 may follow similar steps above to receive specific radio resources for sidelink communication in mode 1 available for the UE 20.

A software application, such as a multimedia, navigation, phone, walkie-talkie (in either half-duplex or full-duplex) or IM (Instant Messaging) application which supports a chat function, is preferred pre-installed in the UE 20 (or device 10). Chat function refers to a function to deliver voice messages to another UE and vise verse. Because the UE 20 is registered to the cellular network and able to link the internet, a user, such as Brad, is able to download the software application from the internet or an application server (in either a push or pull way) and install and store the software application in the device 10. The software application is placed in the application layer and able to initiate or activate all types of services supported by the UE 20 or the cellular network. The software application also sends/provides data for the UE 20 to transmit and vise verse.

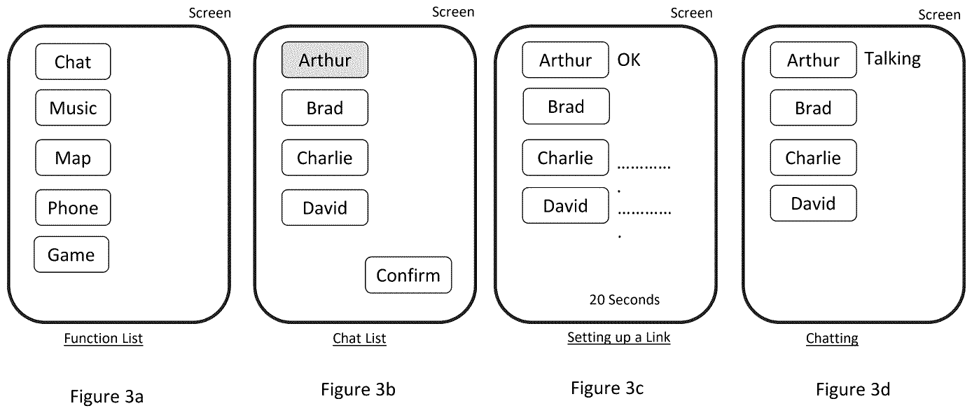

Step S21: Receiving a command to initiate or activate a chat function. FIG. 3a illustrates a UI (User Interface) of the software application on a touch screen of the UE 20. Several icons representing different functions are shown on the UI. For example, one icon refers to a chat function, another icon refers to a music function and so on. A command is generated by the software application when the icon referring to the chat function is pressed by the user Brad. The chat function of the software application is initiated/activated accordingly. Of course, besides the UI interface on the touch screen, by pressing a keyboard or bottom on the device 10, or recognizing a voice command received from a microphone of the device 10, the software application is able to generate the command to initiate or activate the chat function of the software application as well.

Step S22: Providing a Chat list for selection and the selection refers to a destination UE. When the chat function is initiated or activated, the software application displays a Chat list on the UI for the user Brad to select. Contacts or Directories, as commonly used in a smartphone, is a default function of the UE 20 (or device 10). The user Brad sets up Contacts or Directories when having the UE 20. After the software application is installed, the application server requests the UE 20 to synchronize or upload their Contacts or Directories to the application server when the UE 20 is connected to the cellular network. Therefore, the application server owns a copy of the Contacts or Directories of the UE 20. The Contacts or Directories encloses lots of user information, such as user names, phone numbers, nicknames, calling history, short messages, representative pictures and so on. As an owner of the UE 20, the user Brad is able to configure which version of Contacts or Directories, the one stored in the UE 20 or the one stored in the application server, is chosen. In this embodiment the Contacts or Directories stored in the application server is chosen for illustration purpose only.

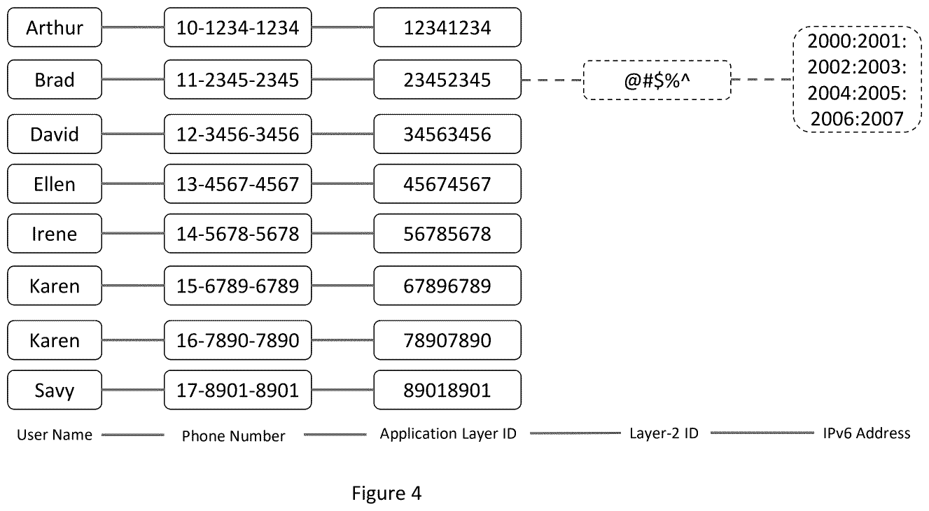

After receiving the Contacts or Directories from the UE 20, the application server is able to build a Chat list based on the information of user names or phone numbers. The Chat list may be extended based on the Contacts or Directories or a separate list from the Contacts or Directories. The Chat list records the below information: user names, phone numbers, Application Layer ID, Layer-2 ID, and additional information, such as nickname, PSID (Provider Service ID) ITS-AID (ITS Application ID) or IP address as illustrated in FIG. 4. As illustrated, some of the information is ready and the remaining will be added later on. The Chat list is preferred indexed by user names since it is recognizable by the user Brad easily. Some of the information of the Chat list is displayed on the UI, such as user names or nickname. Other information, such as the Application Layer ID, Layer-2 ID, PSID and ITS-AID, is concealed, encoded or not displayed on the UI.

When the chat function is initiated/enabled, the software application downloads or synchronizes the Chat list with the application server by either a push or pull way. Since the chat list and Contacts or Directories have some information in common, the Chat list may be incorporated into the Contacts or Directories by adding its information into the Contacts or Directories. The software application may ask the ASIC/CPU 22 to store the Chat list to RAM/ROM 26. Later on, if the UE 20 is not able to connect to the cellular network, the software application may read the stored Chat list and display it on the UI for the user Brad to select. Of course, with or without the connection to the cellular network, the software application provides a UI for the user Brad to key-in the content into the Chat list, or revise the content.

When showing the Chat list with the user Brad, it is optional to the software application to indicate which user is available to chat. The application server asks the UEs of the online users to provide their GNSS information in order to calculate their location regularly. For example, by calculating the location values of the users Brad and Arther, the application server determines a value of their distance. If the user Arthur is online and within a certain value of distance, such as 300 meters, the application server forwards a positive value to the software application. The software application expresses on the UI that the user Arthur is available to chat as illustrated in FIG. 3b by highlighting the name.

Step S23: Determining a source Application Layer ID corresponding to a source UE and a destination Application layer ID corresponding to the destination UE. When a contact is selected, such as Arthur is selected, a sidelink communication from the UE 20 to the UE of the user Arthur is desired to be established. In this communication the source device refers to the UE 20 and the destination device refers to the UE of user Arthur.

The Application Layer ID is preferred to be retrieved from or transformed by, completely or partially, device ID, vehicle ID (e.g., Vehicle Identification Number (VIN)), user ID, application ID, MEID (Mobile Equipment ID), PSID, ITS-AID or IP address of the UE 20, or assigned randomly by the application server or the cellular network (such as V2X Control Function). It is also doable that when the software application is initiated, the user Brad is allowed to key-in the value of device ID, user ID, application ID on the UI and the value is stored by the software application (as well as the application server). The Application Layer ID is unique, supposed to be permanent before a timer expires or before the reset of the software application.

Assuming the users Arthur, David and Ellen also installs the software applications in their devices, therefore the application server has the values to their Application Layer IDs after synchronization or upload, and incorporates their Application Layer IDs into the Chat list. Users Irene, Karen, Leon and Savy may not install the software application yet. In such a situation the application server may assign preliminary/default values to their Application Layer IDs since they are shown on the Chat list.

The software application on the UE 20 has several ways to determine an Application Layer ID of Arthur (an Application Layer ID of the UE of user Arthur actually). If Arthur's Application Layer ID is known to the software application in the prior communication, it is determined to re-use it as the Destination Application Layer ID. When the UE 20 is connected to the cellular network, Arthur's Application Layer ID on the Chat list is likely updated. The software application treats Arthur's Application Layer ID as the Destination Application Layer ID. If the software application does not have Arthur's Application Layer ID, a default value is assigned/determined by the software application or the application server and it is treated as the Destination Application Layer ID.

The IP address may be IPv4 or IPv6 address. IP address is either assigned by the application server, the cellular network or auto-configured by the UE 20 itself. The value of the IP address may be the one assigned or configured in the prior procedure or a default value. The user Brad is also allowed to set the value of the IP address.

Step S24: Providing a request of service with the source and destination Application Layer IDs. In order to perform the Chat function with the user Arthur, the software application sends a message to request a V2X (Vehicle-to-Everything) or ProSe (Proximity Services) service to the UE 20. The software application also provides the source Application Layer ID and destination Application Layer ID to the UE 20.

Step S25: Determining a source Layer-2 ID corresponding to the source UE and a destination Layer-2 ID corresponding to the destination UE. Taking the ProSe service as an example, after receiving the request of ProSe service with the source and destination Application Layer IDs from the software application, the ProSe layer responding to the ProSe service takes actions to determining a Layer-2 ID of UE 20 and a Layer-2 ID of the user Arthur. The Layer-2 ID may be come out by calculating the value of the Application Layer ID, device ID, vehicle ID, user ID or application ID of the UE 20 completely or partially. If the above ID is changed due to configuration or modification, the Layer-2 ID shall be changed as well. The Layer-2 ID may also be assigned by the software application, application server or the cellular network and changed over time.

The ProSe layer has several ways to determine a Layer-2 ID of the user Arthur (a Layer-2 ID of the UE of user Arthur actually). The UE 20 determine Arthur's Layer-2 ID from calculating the value of Arthur's Application Layer ID, phone ID, ICCID, IMSI, device ID, vehicle ID, user ID, application ID, MEID, PSID, ITS-AID or IP address. The UE 20 is also able to find Arthur's Layer-2 ID from a response message from Arthur's UE (as a discoveree) responding to its query message (as a discoverer). The Layer-2 ID of UE 20 is determined as source Layer-2 ID and Arthur's Layer-2 ID is determined as destination Layer-2 ID.

Step S26: Activating a sidelink communication with the destination UE with the source and destination Layer-2 IDs via a PC5 interface. The UE 20 sends an inquiry message, such as UECapabilityInformation, to the cellular network to ask to initiate or activate the service. A response, such as RRCReconfiguration, responding to the inquiry message may be received indicating the parameters used to set up a sidelink communication in mode 1. With the parameters, the UE 20 is able to establish a link with the UE of the user Arthur via a PC5 interface. The UE 20 sends a Direct Communication Request message and SCI (Sidelink Control Information) with the Source Application Layer ID, Source Layer-2 ID, Destination Application Layer ID and Destination Layer-2 ID to the UE of user Arthur. The Direct Communication Request message disclosing the Source and Destination Application Layer IDs is sent on PSSCH (Physical Sidelink Shared Channel) and the SCI disclosing the Source and Destination Layer-2 IDs, either complete or partial, is sent on PSCCH (Physical Sidelink Control Channel). If a Direct Communication Accept message disclosing Source and Destination Application Layer IDs is received, a sidelink between the UE 20 and the UE of user Arthur via the PC5 interface is established which means the UE 20 is able to transmit data to the UE of the user Arthur directly via sidelink mode 1.

The UE 20 shall stay or enter the RRC_CONNECTED state and transmits a Scheduling Request on the PUCCH (Physical Uplink Control Channel) to the cellular network via the UU interface. After the transmission, the UE 20 may receive an Uplink Grant responding to the scheduling request from the cellular network within a certain period via the UU interface.

In order to help the cellular network configure the resources of data communication, the UE 20 transmits a sidelink BSR (Buffer Status Report) to the cellular network to reserve the specific radio resources to data transmission. The UE 20 may receive an Sidelink Grant responding to the sidelink BSR from the cellular network within a certain period. The Sidelink Grant indicates the specific radio resources for the UE 20 for the sidelink communication.

After receiving the Sidelink Grant, the UE 20 is allowed to send data to the UE of user Arthur in sidelink communication using the specific radio resources via the PC5 interface. An indication of establishment of sidelink communication is shown as illustrated in FIG. 3c. Therefore, the user Brad is able to chat to the user Arthur.

Step S27: Generating Sidelink Service Characteristics based on received data and requesting for a semi-persistent transmission with the Sidelink Service Characteristics on the sidelink communication to the cellular network via a UU interface. The user Brad may press the icon of the user Arthur on the UI and start to chat. The software application records the voices to generate a recording file. The software application generates data characteristics and provides them to the UE 20. The data characteristics include latency requirements, such as 10 ms, message size, such as 2.2 kb, and transmission frequency, such as 5 times in a second. The UE 20 translates the data characteristics into a data traffic characteristic, including traffic periodicity, timing offset, and message size. the UE 20 sends an SidelinkUEInformation or UEAssistanceInformation message disclosing the data traffic characteristic to the cellular network via the UU interface.

The UE 20 may receive a Sidelink Configuration Grant message responding to the SidelinkUEInformation or UEAssistanceInformation message from the cellular network via the UU interface within a certain time. The Sidelink Configuration Grant message indicates a configured radio resources for the UE 20 to transmit received data to the user Arthur in a semi-persistent transmission on sidelink.

Step S28: Transmitting the received data to the destination UE in segment on the sidelink communication via the PC5 interface and marking a Cast Type Indicator of a SCI as unicast. After receiving the configured radio resources, the UE 20 is able to transmit the received data on PSSCH to the UE of the user Arthur on the semi-persistent transmission on sidelink communication. Besides transmitting the received data, the UE 20 also marks a Cast Type Indicator of a SCI to indicate the communication type is unicast. Therefore, the link between the users Brad and Arthur is a sidelink unicast communication. On the other hand, the UE 20 is able to receive data from the user Arthur and application software plays the received data to the user Brad as illustrated in FIG. 3d. In order to verify the data transmission and reception, HARQ mechanism is triggered to help trace the data transmission. As to the missed data, the UE 20 may re-send it via a dynamic or the semi-persistent transmission.

The software application may generate real Sidelink Service Characteristics reflexing the real received data. However, in order to reserve more configured radio resources or longer, the software application may generate pseudo Sidelink Service Characteristics which has extensive characteristics, such as larger message size, than the real received data. Therefore, the cellular network may assign extensive configured radio resources for the UE 20 to transmit the received data smoothly and reduce the frequency of requesting for a semi-persistent transmission.

The user Brad is able to talk to the user Arthur via the sidelink communication after the initiating/activating the Chat function. The voice of the user Brad is record when the icon representing the user Arthur is pressed or not deactivated. The user Brad is also able to talk to another user, such as Karen, following the steps as illustrated in the first embodiment if the icon representing the user Karen is pressed in step 21. Beside the recording file, the UE 20 is also able to transmit a vehicle status to the user Arthur via the sidelink communication as well. The software application or the UE 20 is able to decode the vehicle status based on the content or a cause value and expresses it on the icon or a pop-up message on the screen or UI.

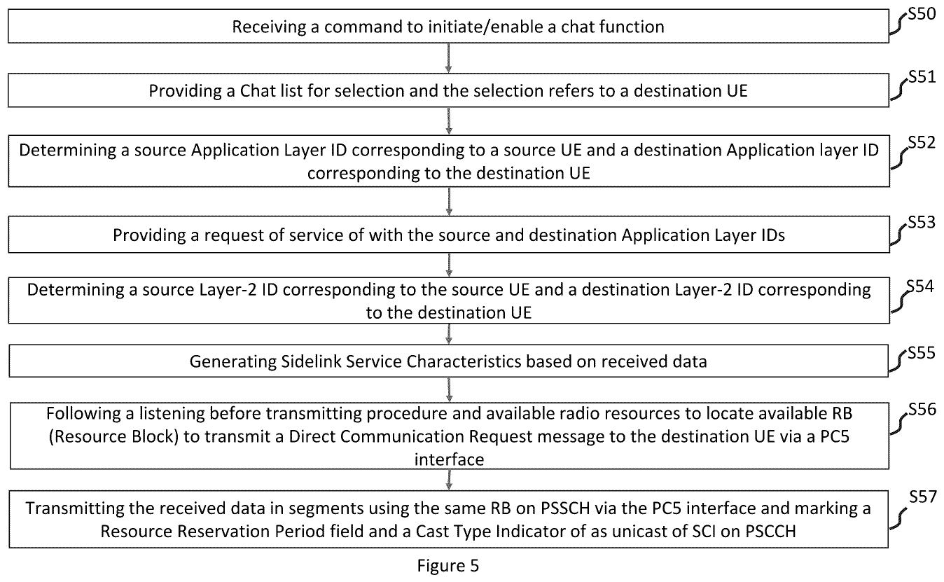

FIG. 5 illustrates a second embodiment of the method of setting up a sidelink mode 2 communication by the UE 20. In this embodiment the UE 20 is not able to connect to the cellular network for some reasons, such as out-of-coverage of the service of the cellular network.

Step S50: Receiving a command to initiate or enable a chat function. Step S50 is similar with step S21. A command is generated by the Device 10 or UE 20 when the icon referring to the chat function is pressed by the user Brad, the chat function of the software application is initiated/enabled accordingly.

Step S51: Providing a Chat list for selection and the selection refers to a destination UE. Step S51 is similar with step S22. When the chat function is initiated or enabled, the software application displays a Chat list on the UI for the user Brad to select. Although the UE 20 does not connect to the cellular network, the software application is still able to build the Chat list based on the Contacts or Directories, or follow a similar method taken in step S22 to build the Chat list, and display the Chat list on the UI for the user Brad to select.

Step S52: Determining a source Application Layer ID corresponding to a source UE and a destination Application layer ID corresponding to the destination UE. Step S52 is similar with step S23. When a contact is selected, such as Arthur is selected, a sidelink communication from the UE 20 to the UE of the user Arthur is desired to be established. In this communication the source device refers to the UE 20 and the destination device refers to the UE of user Arthur.

The software application determines its Application Layer ID as Source Application Layer ID. The software application on the UE 20 has several ways to determine an Application Layer ID of the user Arthur. If Arthur's Application Layer ID is recorded before, it is determined to re-use it as the Destination Application Layer ID. If the Chat list does not have Arthur's Application Layer ID, a default value is assigned or determined as the Destination Application Layer ID.

Step S53: Providing a request of service of with the source and destination Application Layer IDs. Step S53 is similar with step S24. In order to communicate with the user Arthur, the software application requests a V2X (Vehicle-to-Everything) or ProSe (Proximity Services) service. The software application provides the determined source Application Layer ID and destination Application Layer ID to the UE 20.

Step S54: Determining a source Layer-2 ID corresponding to the source UE and a destination Layer-2 ID corresponding to the destination UE. Step S54 is similar with step S25. Taking the ProSe service as an example, after receiving the request of ProSe service with the source and destination Application Layer IDs from the software application, the ProSe layer of the UE 20 takes actions to determining a Layer-2 ID of UE 20 and a Layer-2 ID of the user Arthur.

Step S55: Generating Sidelink Service Characteristics based on received data. The user Brad may press the icon of the user Arthur on the UI and start to chat. The user Brad may press the icon of the user Arthur on the UI and start to chat. The software application records the voices to generate a recording file. The software application generates data characteristics and provides them to the UE 20. The data characteristics include latency requirements, such as 10 ms, message size, such as 2.2 kb, and transmission frequency, such as 5 times in a second. The UE 20 translates the data characteristics into a traffic characteristic, including traffic periodicity, timing offset, and message size.

Step S56: Following a sensing before transmitting procedure to select available RB (Resource Block) in the following selection window to transmit a Direct Communication Request message to the destination UE via a PC5 interface. After receiving the request of service, the UE 20 verifies whether a sidelink communication is subscripted/authorized and whether provisioning radio resources are available. The available radio resources may be provisioning or updated during the last connection with the cellular network. The UE 20 replies on the available radio resources and the sensing before transmitting procedure to check which RB is available to transmit the Direct Communication Request message on PSSCH to the UE of the user Arthur. The Direct Communication Request message discloses the Source and Destination Application Layer IDs. The UE 20 also transmit the SCI on PSCCH disclosing the Source and Destination Layer-2 IDs, either complete or partial, to inform all the UE that the RB is reserved by the UE 20.

If a Direct Communication Accept message disclosing Source and Destination Application Layer IDs is received, a sidelink communication between the UE 20 and the UE of user Arthur is established which means the user Brad is able to chat to the user Arthur directly via sidelink communication.

Step S57: Transmitting the received data in segments using the same RB on PSSCH via the PC5 interface and marking a Resource Reservation Period field and a Cast Type Indicator of as unicast of SCI on PSCCH. After the link between the UE 20 and the UE of user Arthur is established, the UE 20 uses the located available RB to unicast (by marking the Cast Type Indicator of as unicast) the received data to the UE of user Arthur. Generally speaking, the received data is not transmitted completely once. Therefore, the UE 20 shall transmit the received data in segments using the same RB on PSSCH which means the UE 20 uses the same RB repeatedly several times until completes the transmission. In order to use the same RB repeatedly, the UE 20 marks a Resource Reservation Period field of SCI as well.

When the UE 20 is not able to connect to the cellular network, the user Brad is able to talk to the user Arthur via the sidelink in mode 2 after the initiating or activating the Chat function. The user Brad is also able to talk to another user, such as Karen, following the steps as illustrated in the second embodiment if the icon representing the user Karen is pressed in step 51. Beside the recording file, the UE 20 is also able to transmit a vehicle status to the user Arthur via the sidelink in mode 2 as well. The software application is able to decode the vehicle status based on the content or a cause value and expresses it on the icon or a pop-up message on the screen or UI.

While the embodiments have been described in connection with various aspects, it will be understood that the embodiments are capable of further modifications. This application is intended to cover any variations, uses or adaptation of the embodiments following, in general, the principles of the embodiments, and including such departures from the present disclosure as come within the known and customary practice within the art to which the embodiments pertain.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of setting up a sidelink communication in mode 1, comprising:
registering to a cellular network;
receiving a command to initiate or activate a chat function;
providing a Chat list for selection, wherein the selection refers to a destination user equipment (UE);
determining a source Application Layer identification (ID) corresponding to a source UE and a destination Application layer ID corresponding to the destination UE;
providing a request of service with the source Application Layer ID and the destination Application Layer ID;
determining a source Layer-2 ID corresponding to the source UE and a destination Layer-2 ID corresponding to the destination UE;
activating a sidelink communication with the destination UE with the source Layer-2 ID and the destination Layer-2 ID via a PC5 interface;
generating a plurality of Sidelink Service Characteristics based on received data and requesting for a semi-persistent transmission with the Sidelink Service Characteristics on the sidelink communication to the cellular network via a UU interface; and
transmitting the received data to the destination UE in segments on the sidelink communication via the PC5 interface and marking a Cast Type Indicator of a Sidelink Control Information (SCI) as unicast.

2. The method of claim 1, wherein the Chat list is generated based on Contacts or Directories.

3. The method of claim 1, wherein the Chat list is incorporated into Contacts or Directories.

4. The method of claim 1, wherein the source Application Layer ID and the destination Application Layer ID are stored in the Chat list.

5. The method of claim 1, wherein the source Layer-2 ID and the destination Layer-2 ID are stored in the Chat list.

6. The method of claim 1, wherein the command is a response to an action on a user interface (UI), keyboard, bottom or voice recognition.

7. The method of claim 1, wherein the received data is transmitted by using configured radio resources.

8. The method of claim 1, wherein the source Layer-2 ID is generated by calculating a value of the source Application Layer ID, a device ID of the source UE, a vehicle ID of the source UE, a user ID of the source UE, or an application ID the source UE.

9. The method of claim 1, wherein the Sidelink Service Characteristics at least include a plurality of latency requirements, a message size, and a transmission frequency.

10. The method of claim 1, wherein a value of distance between source UE and the destination UE is lower than a threshold 11. A method of setting up a sidelink communication in mode 2, comprising:
receiving a command to initiate or activate a chat function;
providing a Chat list for selection, wherein the selection refers to a destination user equipment (UE);
determining a source Application Layer identification (ID) corresponding to a source UE and a destination Application layer ID corresponding to the destination UE;
providing a request of service with the source Application Layer ID and destination Application Layer ID;
determining a source Layer-2 ID corresponding to the source UE and a destination Layer-2 ID corresponding to the destination UE;
generating Sidelink Service Characteristics based on received data;
following a sensing before transmitting procedure and available radio resources to locate an available resource block (RB) to transmit a Direct Communication Request message to the destination UE via a PC5 interface; and
transmitting the received data in segments using the RB on physical sidelink shared channel (PSSCH) via the PC5 interface and marking a Resource Reservation Period field and a Cast Type Indicator of as unicast of Sidelink Control Information (SCI) on physical sidelink control channel (PSCCH).

12. The method of claim 11, wherein the available radio resources are either provisioning or updated during a last connection with a cellular network.

13. The method of claim 11, wherein the received data is transmitted in the segments based on a semi-persistent transmission.

14. The method of claim 11, wherein the Chat list is generated based on Contacts or Directories.

15. The method of claim 11, wherein the Chat list is incorporated into Contacts or Directories.

16. The method of claim 11, wherein the source Application Layer ID and the destination Application Layer ID are stored in the Chat list.

17. The method of claim 11, wherein the source Layer-2 ID and the destination Layer-2 ID are stored in the Chat list.
